(19) United States
(12) Patent Application Publication
(10) Pub. No.: US 2023/0059235 A1
(43) Pub. Date: Feb. 23, 2023

(54) TRELLIS FOR PLANTS

(71) Applicant: Steffen Meier, Aschersleben (DE)

(72) Inventor: Steffen Meier, Aschersleben (DE)

(21) Appl. No.: 17/620,150

(22) PCT Filed: Jun. 19, 2020
(86) PCT No.: PCT/EP2020/000116

§ 371 Date: Oct. 31, 2022

(30) Foreign Application Priority Data
Jun. 19, 2019 (DE) 10 2019 004 364.2

(51) Int. Cl. A01G 9/02; A01G 9/12; A47G 7/04

(52) U.S. Cl. CPC A01G 9/02; A01G 9/12; A47G 7/044

(57) ABSTRACT

A trellis comprising a receiving section (2), a trellis structure (3) and a base section (4). The base section has an elongate main form, parts of which can be positioned between the bearing section of a saddle-type planter and the retaining structure. The trellis structure (3) is fixed in position on the base section (4) so that it extends upwards relative to the base section (4).

The invention relates to a trellis for plants according to the preamble of claim 1.

Compared to conventional planters, such as pots and window boxes, saddle-shaped containers are designed to be higher, with the aim of preventing them from tipping and providing a lower center of gravity, as well as compensating for the lack of volume of the soil container due to the tunnel under the central bar between the soil container sides.

Compared to this taller container shape, the height that the plant can reach without trellises remains unchanged.

The saddle-shaped container conveys a visual imbalance in the proportions of the taller container, compared to which the lower growth of the plants appears kept back and incidental.

However, users primarily value abundant plant growth.

Conventional planters, such as pots and balcony boxes, are due to their height less conspicuous in their appearance compared to the height of the plants that can be achieved without trellises, but trellises stored flat and in loose planter soil are often unstable to plant weight, wind pressure and fruit weight.

Conventional trellises are to be inserted in saddle pots and in soil containers of balcony boxes. This requires working with the soil and two pieces of conventional trellises in saddle pots, in order to be anchored deep in each soil container side. These saddle pots are narrower compared to pots and boxes, and trellises anchored therein take up space.

Above all, vegetation from the depths of each soil container side blocks the line of sight because viewers usually look at the saddle-shaped containers on railings from a transverse direction, with the soil container sides being arranged one behind the other in the line of sight.

The design value possible with vegetation from the depths of each side of the soil container, even on areas enlarged by trellises, is not achieved in this way.

Trellises which extend as an upwardly extended rear wall mostly on heavy floor containers are complex to manufacture as an integral part of the container and multiply the height of the planter, which increases transport costs. Even as separate add-on parts, they follow the length of the wall of the container, and overhangs for designing a larger side length do not find support away from the rear wall.

Conventional trellises usually do not offer a shelf for plants having fruit lying on the ground. Balcony shelves that can be arranged on railings are made of flat solid material and have the top similar to that of a bureau. They are hung low on railings on one side, extending below the railing into the balcony space and could accommodate planters and fruit, although they disadvantageously face away from the sun. These are visible behind the walls of the railing and shelf only in the balcony space, without having an effect on the outside. Climbing growth is not assisted, in particular without a trellis structure, since the shelves are designed as furniture for the users in front of them as a stable and fall-proof shelf for objects.

DE20316948U1 describes a conventional outdoor trellis as a closed part and as an archway, with the closed part having a passage in the middle. Attachment on a saddle-shaped container is neither intended nor possible for either version. Lacking is a base whose upper contour and lower contour each correspond to corresponding structures of a saddle-shaped container and a support structure that could rest on these structures at all and which is at least partially arranged between the support section of a saddle-shaped container and the support structure.

Furthermore, conventional trellises such as those disclosed in DE20316948U1 do not have any element that accommodates a separate connecting element, for example an adapter or cable tie, for attachment to a saddle-shaped container and/or around a railing handrail.

Each version of the conventional outdoor trellis can only be anchored in the ground using downwardly protruding foot elements. Applying the conventional trellis with its foot element and/or foundation in saddle-shaped containers requires effort and space, which is significantly tighter in narrow soil container halves of the saddle-shaped containers than in other containers. This narrow volume of soil, in contrast to garden soil, which has a more compact density, is formed from loose plant pot soil as is usual in planter pots and cannot provide the stability required to secure foundations and/or conventional trellises stably in the soil container or against wind and to withstand the weight of plants and fruits.

Disadvantageously, the soil must be worked in any case in order to fix conventional trellis, such as DE20316948U1, in the soil of the saddle-shaped container.

Such conventional trellises usually end at their outer attachments. Their use in the soil of planters requires a narrow design terminating in the soil, so that conventional trellises are unable to follow longer horizontal courses, for example railings, and, in an extended version, are also not allowed to for reasons of stability. On longer courses, such as along railings, the leverage effect causes significantly increased stresses with increasing length, which a trellis affixed in the planter soil cannot withstand.

The lever rule causes significantly increased stresses with increasing height on longer trellises, which the trellis attachment in the planter soil cannot withstand.

Narrow conventional trellises, such as DE20316948U1 used in saddle tanks, form only small areas, which is disadvantageous for picking up vine growth from two sides of the soil container. Two pieces of conventional trellises, one on each side of the soil container, take up the growth of both soil container sides, which disadvantageously translates into twice the number and twice the effort when attached in the narrow volume consisting of loose soil, with the aforedescribed disadvantages.

A particular disadvantage when using two pieces of conventional trellises is that vegetation from each side of the soil container is hidden in the line of sight, since railings and saddle-shaped containers are usually attached transversely in front of the viewer. The growth on the conventional trellis of the soil container on the inside of the balcony obscures the growth on the parallel conventional trellis on the outside of the balcony because the soil container sides are arranged parallel one behind the other in the line of sight.

The design value possible with vegetation from the depths of each side of the soil container, even on areas enlarged by trellises, is not achieved in this way.

Also lacking are wide growth patterns and a multidimensional design beyond the planter.

WO 2013/114 261 A1 describes a saddle-shaped container which has a concave indentation on its underside, which has an essentially elongated support structure which is designed to transfer a weight force of the saddle-shaped container to an elongated support structure. The use of WO 2013/114 261 A1 as a trellis, or attachment to such, is neither intended or possible. With the soil work and the disadvantages described, a conventional trellis can be used.

It is the object of the invention to create a simple, practical trellis, supplementable or as a device with at least one planter, which can be arranged without soil work cleanly and stably on elongated support structures such as railings, saddle-shaped containers and conventional planters. Plant growth should be clearly visible.

The area designed with plants and fruits should be less dependent of the dimensions of the planter. Plants and fruits should have a sunny location.

As stated in the claims, this is achieved in that the trellis (1) is fixed to the saddle-shaped container and/or to an elongate support structure, for example a railing, and preferably at least partially accommodates a contour of the saddle-shaped container. For this purpose, the trellis (1) has at least one receiving section (2) which is designed and constructed as a free space in the trellis structure (3) to preferably accommodate at least the cross-section from the upper side of the railing of the saddle-shaped container in such a way that the trellis structure (3) is arranged above or below the planter opening. On the saddle-shaped container with a continuous base section (4), the receiving section (2) is further designed to guide a soil container side of a saddle-shaped container through the free space so that the base section (4) reaches under the support section of the saddle-shaped container and the trellis structure (3) is arranged above the planter opening. In this case, the receiving section (2) is designed in a simple form as a gap in the trellis structure (3) or is delimited by an, for example, arcuate, closing strip between the ends of the structures of the trellis structure (3) on the receiving side. The clearance profile of the receiving section (2) formed, with or without a closing strip, corresponds to the shape and dimensions of at least the radius of the saddle-shaped container to be accommodated when using round saddle-shaped containers or for other plant container shapes, at least half their longitudinal cross-section.

Preferred embodiments will be evident from the dependent claims and the figures, which show in:

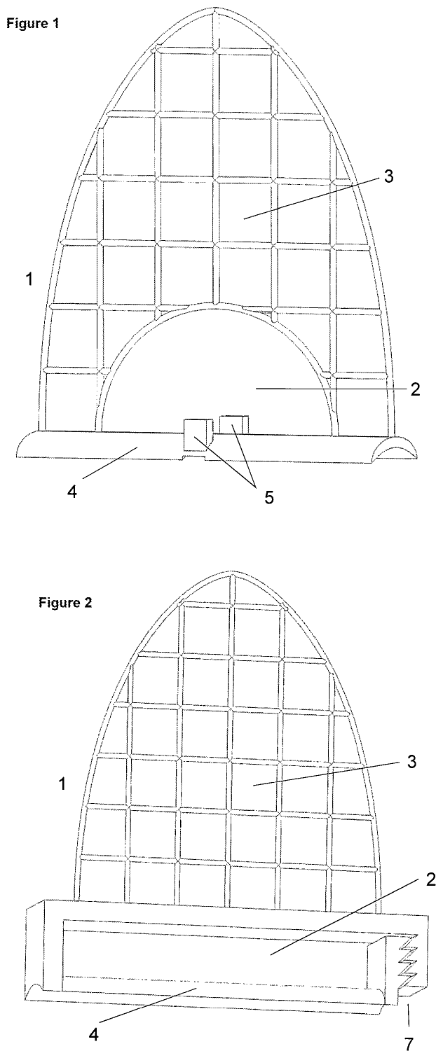

FIG. 1 the trellis with a continuous base section,

FIG. 2 the trellis with separable receiving section,

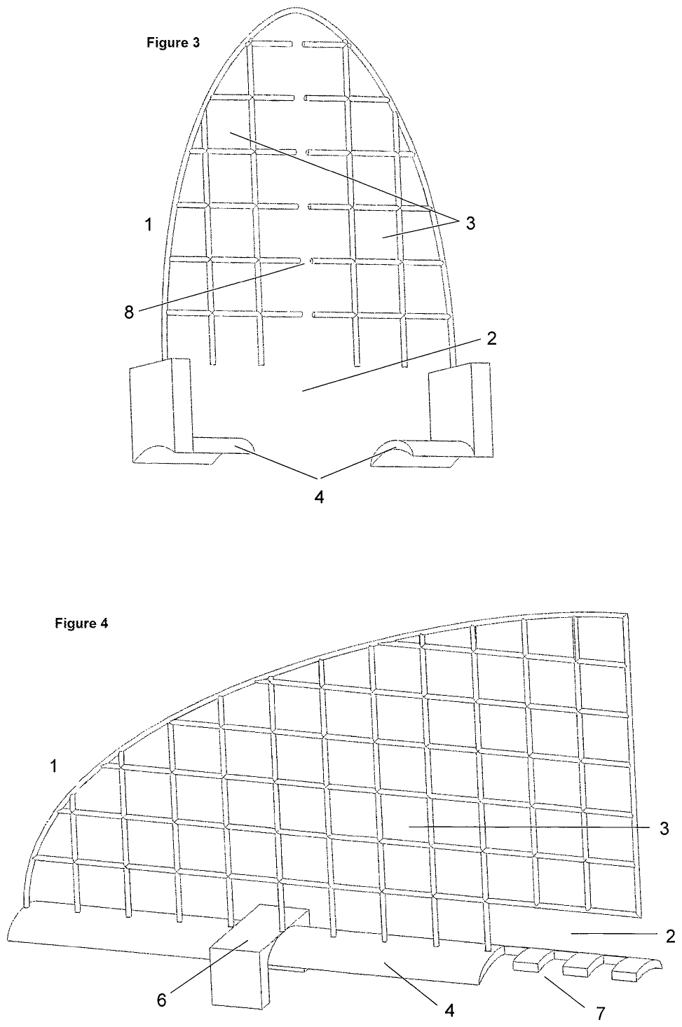

FIG. 3 the trellis clasp,

FIG. 4 the trellis, which can be arranged in two parts,

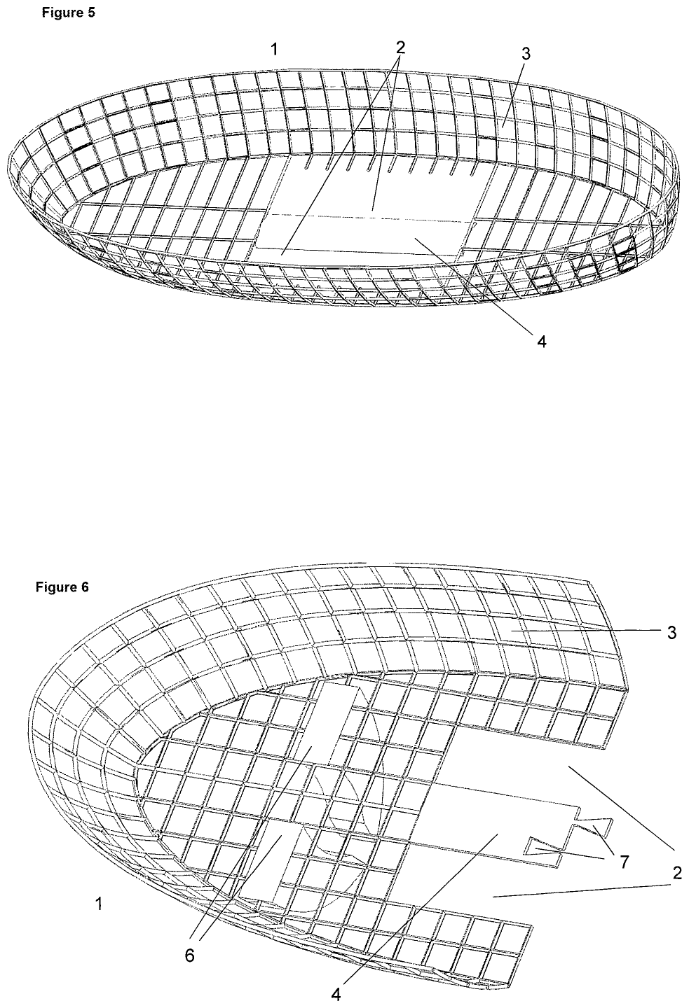

FIG. 5 the trellis for fruit-bearing plants,

FIG. 6 the trellis, which can be arranged in two parts, for fruit-bearing plants.

The trellis (1) has a configuration of a trellis structure (3) and a base section (4), which is designed to guide the brackets of a balcony box on the base section (4) so that the brackets of the balcony box are disposed on the base section (4).

The trellis structure (3) is designed as a structure that is constructed to give support to plant growth, for example a lattice, spiral, rhombus or mesh. The structure may also be irregular and imitate characters, symbols or silhouettes, for example silhouettes of living beings, letters, logo, pagoda, tree, plant, building, cityscape, leaf or graphic shape.

The course of the structure can be two-dimensional, for example in the form of a lattice, also around corners, or three-dimensional, such as living beings, a vehicle or a building, for example in the form of a tower.

The structure may be irregular and imitation of characters, symbols or silhouettes, for example silhouettes of living beings, letters, logo, pagoda, tree, plant, building, cityscape, leaf or graphic shape.

The course of the structure may be two-dimensional, for example in the form of a lattice, also around corners, or three-dimensional, such as living beings, a vehicle or a building, for example in the form of a tower.

An advantageous embodiment of the trellis structure (3) has elastic structures or interruptions between structures near the receiving section (2), which make them elastic when passing through a soil container side of a saddle-shaped container.

A further advantageous embodiment of the trellis structure (3) has predetermined breaking points arranged near the receiving section (2), which are designed to widen the receiving section (2).

Another advantageous embodiment of the trellis structure (3) has predetermined breaking points, which are designed to customize its dimensions and shape.

An advantageous embodiment of the base section (4) is adapted in its longitudinal cross-section to an elongate, for example curved, support structure.

A preferred embodiment of the base section (4) is flexible and adapts under the weight of the saddle-shaped container to the surface contour of an elongate support structure, for example the top a railing on which the base section (4) is arranged.

A partially elastic design of the base section (4) is designed, for example, to have a material cross section that is large in the longitudinal center of the base section (4) and tapers towards the outside.

The base section (4) is connected to the trellis structure (3) at a fixed position. In an advantageous embodiment, this connection is detachable and has a base section (4) with two different cross-sections, for example with a flat cross-section and with a cross-section curved in the longitudinal direction, with the base section being able to be arranged on the trellis structure (3) so that it can be turned. Another advantageous embodiment of the base section (4) consists of planes of the base section (4) which are detachably connected to one another. The upper level is connected to the trellis structure (3) at a fixed position. A lower level of the base section (4) has two sides, each with different cross-sections, for example with a flat cross-section and with a cross-section that is curved in the longitudinal direction, which can be arranged on an upper plane, connected, for example, with a trellis structure (3).

An advantageously variable embodiment of the base section (4) has predetermined breaking points, the separation of which changes the dimensions of the base section (4).

A structure that is not shown in detail in the drawing and that may be arranged above the base section (4) as an integral part of the trellis (1) starting from the base section (4) or as a separate add-on part, running in the direction of the support section of the planter, is formed to fill a free space between the top of the base section (4) and the support section and to improve the weight transfer from the saddle-shaped container to the base section (4).

A connecting element, not shown detail in the drawing, which if required can be arranged over the base section (4), for example a double-sided adhesive pad or double-sided adhesive strip in the direction of the support section of the planter, is designed to connect the base section (4) and the support section of a planter to one another. The base section (4) has vertically oriented passages (not shown in detail in the drawing) for arranging further elements, for example screws, designed to connect the base section (4) and the support section of a planter to one another.

Preferably, the trellis (1) has adapters (5) designed to connect the trellis to the planter. The adapters (5) are separate parts or part of the trellis (1). Separate adapters (5) are advantageously designed as hollow profiles for connecting the trellis (1) and the saddle-shaped container to one another, for example by being arranged vertically in the passages of the trellis (1) and the saddle-shaped container.

In an advantageous embodiment, adapters (5) as part of the trellis (1) are arranged opposite one another on the top side of the base section (4) as an upward-pointing structure, for example designed as vertical profiles spaced apart from one another, which can be accommodated in a corresponding lower contour of the planter.

Corresponding lower contours on conventional saddle-shaped containers are, for example, openings for cable ties running for the purpose of attachment under the intermediate web of the soil container sides, with the adapters (5) being accommodated in the openings. The adapters (5) as vertically oriented profiles are advantageously designed as hollow profiles and accommodate connecting elements, for example cable ties, in order to guide these through the base section (4).

In this connection, the cable tie runs through the lower contour of the planter, then through the adapter (5), the base section (4) and then envelops an elongate support structure, for example a railing, being pressed against the trellis (1) which is then in turn pressed against the corresponding lower contour of the planter.

In a similar connection, the cable tie runs through the lower contour of the planter, further through openings designed for example as gaps and arranged in the base section (4), and envelops the base section (4) only between the openings, which is then in turn pressed against the corresponding lower contour of the planter.

The cable tie runs longer through the lower contour of the planter and further in recesses arranged opposite one another on the longitudinal side edges of the base section (4), wherein the base section (4) is broadly, almost completely, enveloped and pressed against the corresponding lower contour of the planter.

A base section (4) designed advantageously for connecting elements, for example cable ties, has troughs or recesses disposed below the course of the cable tie, the width and depth of which are dimensioned such that the contour of the base section (4) remains unchanged when cable ties are arranged.

Saddle-shaped containers designed for the trellis (1) advantageously have corresponding lower contours for adapters (5), for example receptacles provided for the adapters. These receptacles are designed as recesses which accommodate a vertically oriented contour of the trellis (1).

An advantageous lower contour of the saddle-shaped container for the basket-shaped trellis (1) is, for example, its support section, which transfers the weight of the saddle-shaped container to an elongate support structure designed to accommodate an upper contour of the base section (4). This design represents, for example, recesses formed as a negative impression of the base structure, which accommodates them.

From the base section (4) extends a downward structure as an attachment (6) which fastens the trellis (1) to an elongate support structure, such as a railing.

The attachment (6) is designed as an integral part of the trellis (1) and or as a separate part. Integral attachments (6) as components of the trellis (1) run along the base section (4) or are arranged individually and are designed, for example, as clips or brackets pointing downwards on the sides of the base section (4) to create a connection between the trellis and an elongate support structure. The attachments (6) are designed to be fixed or elastic in terms of shape, course, cross-sectional design, and material properties.

When the attachments (6) as an integral part of the trellis (1) are directed downwards on the sides of the base section (4), they accommodate the elongated support structure, like a railing, over a short length like a clamp or in a longer version like a tunnel, whereby the attachments also bear against the sides.

Advantageously, the height of the downwardly pointing side of the attachment (6) is dimensioned, at least in sections, so as to terminate approximately in the lower plane of the support structure that can be gripped from underneath, with a separate attachment (6), for example a clip arranged transversely to the support structure, overlapping the base section (4) and engaging under the underside of the support structure. To advantageously connecting the trellis (1) with separate attachments, the base section (4) has, preferably on its top side, suitable structures, such as rough surfaces or locking teeth, which communicate with the structures of the separate attachments.

Separate attachments (6) are designed, for example, as clasps, clamps or cable ties which create a connection between the trellis and an elongate support structure.

A separable embodiment of the receiving section (2) is arranged below the base section (4) and is designed in the shape of a clasp and is provided with a detent (7) which is arranged on the front side and/or on the longitudinal side. The base section (4) is at the same time the upper leg of the clip and is connected at one end by a vertical web to the leg running parallel below it. Respective detents (7) which face each other and at least partially overlap are arranged at the separable end of both legs. The height of the intermediate web and notches (7) are designed such that the upper clip leg formed by the base section (4) extends over the soil container of the saddle-shaped container and the lower clip leg engages under the support section of the saddle-shaped container.

The clasp-shaped trellis (1) has a separation (8) designed as a vertically oriented gap through the base section (4), the receiving section (2) and the trellis structure (3), which terminates below the outermost upper horizontally directed structure, preferably made of an elastic material. The outermost structure above the separation (8) is designed as, for example, an arcuate enclosure of the trellis structure (3) or another horizontally directed structure, for example a trellis web.

The receiving section (2) is arranged over the base section (4) and accommodates the contour of a saddle-shaped container. The base section (4) is designed separately, the sections of which are detachably designed as non-touching stubs or as at least partially overlapping structures that communicate with one another, for example locking teeth. A planter intended for the stub-shaped base sections (4) has, as a corresponding structure, horizontally directed receiving compartments arranged, for example, on its sides, which are designed to receive the stubs. The detachable design of base section (4) is designed with base section sides having overlapping lengths interacting with one another, for example as interlocking recesses and projections or as a detent. The distance between the base section (4) and the trellis structure (3) is designed in such a way that the trellis structure (3) is arranged above the soil container of the planter and the base section (4) engages under the support section of the saddle-shaped container.

The separation (8) in the trellis structure (3) is designed as a gap or as releasable and interacting elements arranged along the separation (8), for example trellis webs that can be plugged into one another or as a snap-in connection of the same. A releasable configuration of the trellis structure (3) is also possible by connecting the trellis structure sides, for example clamps or binders.

A bridge-shaped trellis (1), not shown in the drawing, has at least one receiving section (2) configured to receive the cross section from the top side of the railing of the saddle-shaped container such that the trellis structure (3) is arranged over the planter opening and has at least one attachment (6), which is designed to connect the trellis (1) to a communicating structure of the saddle-shaped container and/or of an elongate support structure.

A preferred communicating structure of the saddle-shaped container is designed, for example, as a receptacle arranged in a horizontally directed container structure, such as the upper rim of the container, and implemented as openings or notches, into which a vertically oriented structure of the trellis (1) engages.

An advantageous communicating structure of the saddle-shaped container is designed as a claw, an eyelet or a detent protruding from the planter, into which a vertically oriented structure of the trellis (1) engages.

Another attachment (6) is designed as a vertically oriented structure, for example as a downwardly extended trellis structure (3), with the other attachment (6) arranged above the saddle-shaped container, accommodating the sides of which the planter walls and/or bearing against the inner wall and/or outer wall of the planter.

The trellis structure (3) is designed as a structure that provides support for plant growth, for example a lattice, scissor lattice, spiral, rhombus or mesh. The structure can also be irregular and a replica of characters, symbols or silhouettes, such as silhouettes of living beings, letters, logo, pagoda, tree, plant, structure, cityscape, leaf or graphic shape.

The course of the structure can be two-dimensional, for example in the form of a lattice, also around corners, or three-dimensional, such as living beings, a vehicle or a building, for example in the form of a tower.

The structure can also be irregular and imitate characters, symbols or silhouettes, for example silhouettes of living beings, letters, logo, pagoda, tree, plant, building, cityscape, leaf or graphic shape.

The course of the structure can be two-dimensional, for example in the form of a lattice, also around corners, or three-dimensional, such as living beings, a vehicle or a building, for example in the form of a tower.

An advantageous embodiment of the trellis structure (3) has predetermined breaking points arranged near the receiving section (2), which are designed to widen the receiving section (2).

Another advantageous embodiment of the trellis structure (3) has predetermined breaking points, which are designed to customize their dimensions and shape.

An advantageous embodiment of the base section (4) has predetermined breaking points, the separation of which changes the dimensions of the base section (4).

A downwardly oriented structure forming an attachment (6) which fastens the trellis (1) to an elongate support structure, such as a railing, extends from the base section (4). The attachment (6) is designed as an integral part of the trellis (1) and or as a separate part. Integral attachments (6) as components of the trellis (1) run along the base section (4) or are arranged individually and, for example, as clips or brackets oriented downward on the sides of the base section (4) to create a connection between the trellis and an elongate support structure. With respect to shape, course, cross-sectional design, material properties, attachments (6) are designed to be solid or elastic.

When attachments (6) as an integral part of the trellis (1) run down the sides of the base section (4), they accommodate the elongated support structure, for example a railing, over a short length like a clamp or in a longer version like a tunnel, whereby they also abut the sides.

Advantageously, the height of the downwardly oriented attachment (6) at the side is dimensioned, at least in sections, such that it ends approximately in the lower plane of the support structure that can be gripped from underneath, and a separate attachment (6), for example formed as a clip arranged transversely to the support structure, overlaps the base section (4) and engages under the underside of the support structure. To advantageously connect the trellis (1) with separate attachments, the base section (4) has, preferably on its top side, suitable structures, such as rough surfaces or locking teeth that communicate with structures of separate attachments.

The separate attachments (6) are designed, for example, as clasps, clamps or cable ties which create a connection between the trellis and an elongate support structure.

The separate attachments (6) are designed, for example, as clips, clamps or cable ties which are designed to create a connection between the trellis and an elongate support structure.

A long version of the trellis (1) that is advantageous for large areas is designed in such a way that two trellises that can be arranged on the receiving side are connected to one another. For this purpose, the base section (4) under the receiving section (2) has a, for example comb-shaped, structure that matches the opposing structure, in that recesses and projections interlock.

The corresponding elements create a connection between the trellises (1).

The recesses and projections are, for example, polygonal or round and their dimensions, for example in a comb-shaped structure, are advantageously designed in relation to the saddle container diameters in such a way that the displacement by one or more structures corresponds to a suitably offset receiving section (2) for a different planter diameter.

The receiving section (2) is designed as an opening with an open end below the trellis structure (3) and above the base section (4), with the distance between the base section (4) and the trellis structure (3) designed so that the trellis structure (3) is arranged above the soil container of the saddle-shaped container and the base section (4) engages under the support section of the saddle-shaped container.

The base section (4) reaches under the support section of the planter, with the sides of the saddle-shaped container being surrounded by the respective receiving section (2). A trellis (1) configured for arrangement on a plurality of saddle-shaped containers has a plurality of receiving sections (2) and, for example one-sided, base sections (4) arranged on the outer sides of the trellis (1), so that a saddle-shaped container rests on two half base sections (4) and two half receiving sections (2) are arranged over its opening.

Another example of the trellis (1) configured for arrangement on a plurality of saddle-shaped containers has several receiving sections (2) and base sections (4) arranged, for example, within the trellis structure (3). The receiving sections (2) and the base sections (4) can also be arranged within the trellis structure (3) and on the outer sides of trellis (1).

The trellis structure (3) is designed as a structure which supports plant growth, for example a lattice, a scissor lattice, a spiral, a rhombus or a mesh. The structure can also be irregular and imitation of characters, symbols or silhouettes, for example silhouettes of living beings, letters, logo, pagoda, tree, plant, building, cityscape, leaf or graphic shape.

The course of the structure can be two-dimensional, for example in the form of a lattice, also around corners, or three-dimensional, such as living beings, a vehicle or a building, for example in the form of a tower.

The trellis structure (3) is designed as a structure that is designed to lend support to plant growth, for example a lattice, a spiral, a rhombus, a braid. The structure can also be irregular and imitate characters, symbols or silhouettes, for example silhouettes of living beings, letters, logo, pagoda, tree, plant, building, cityscape, leaf or graphic shape.

The course of the structure can be two-dimensional, for example in the form of a lattice, also around corners, or three-dimensional, such as living beings, a vehicle or a building, for example in the form of a tower.

The structure can also be irregular and imitate characters, symbols or silhouettes, for example silhouettes of living beings, letters, logo, pagoda, tree, plant, building, cityscape, leaf or graphic shape.

The course of the structure can be two-dimensional, for example in the form of a lattice, also around corners, or three-dimensional, such as living beings, a vehicle or a building, for example in the form of a tower.

The respective lengths of trellis structure (3) and base section (4) are identical or different.

In a more stable embodiment, the trellis structures (3) facing one another are designed as mutually corresponding elements, for example opposing trellis webs, detents or clamps that can be plugged into one another.

In a further advantageously stable embodiment of the trellis structure (3), trellis structures (3) slide sideways along one another and overlap one another, wherein trellis structures (3) that face one another are designed as mutually corresponding elements, for example interlocking trellis webs, detents or clamps.

A downwardly oriented structure forming an attachment (6) which fastens the trellis (1) to an elongate support structure, such as a railing, extends from the base section (4). The attachment (6) is designed as an integral part of the trellis (1) and or as a separate part. Integral attachments (6) as components of the trellis (1) run along the base section (4) or are arranged individually and are designed, for example, as clasps or brackets pointing downwards on the sides of the base section (4) and to creating a connection between the trellis and an elongate support structure.

With respect to shape, course, cross-sectional design, material properties, the attachments (6) are designed to be solid or elastic.

When the attachments (6) as an integral part of the trellis (1) extend downwardly on the sides of the base section (4), they accommodate the elongated support structure, like a railing, over a short length like a clamp or in a longer version like a tunnel, whereby they also bear against the sides.

The height of the attachment (6) directed laterally downwards is advantageously dimensioned at least in sections such that the attachment terminates approximately in the lower plane of the support structure that can be grasped from below, and a separate attachment (6), for example as a clip arranged transversely to the support structure, overlaps the base section (4) and engages under the underside of the support structure. For the advantageous connection of the trellis (1) with separate attachments, the base section (4), preferably on its top side, has suitable structures, such as rough surfaces or locking teeth, which communicate with structures of separate attachments.

Separate attachments (6) are designed, for example, as clasps, clamps or cable ties, which create a connection between the trellis and an elongate support structure. An attachment (6) which fastens the trellis (1) to an elongate support structure extends downward from the base section (4). With respect to shape, course, cross-sectional design, material properties, the attachments (6) are designed to be solid or elastic.

An advantageous embodiment of the trellis (1) for fruit-bearing plants has a structure which is basket-shaped in cross section and which receives fruit and forms the trellis structure (3) predominantly on the vertically oriented outer edge.

This structure is as a basket-shaped body an integral part of the trellis (1).

The trellis structure (3) is designed as a structure that lends support to plant growth, for example a lattice, a spiral, a rhombus or a mesh. The structure can also be irregular and imitate characters, symbols or silhouettes, for example silhouettes of living beings, letters, logo, pagoda, tree, plant, building, cityscape, leaf or graphic shape. The course of the structure can be two-dimensional, for example in the form of a lattice, also around corners, or three-dimensional, such as living beings, a vehicle or a building, for example in the form of a tower.

Arranged on the underside of the body in the base section (4) are receptacle sections (2) which are spaced apart from the longitudinal center and are designed as openings in the basket structure, accommodating and enclosing the soil container sides of a saddle-shaped container.

Structures on the underside of the body, which are arranged near the receiving section (2) or protrude into it, are advantageously designed to be elastic.

The base section (4), arranged between the receiving sections (2), is designed to reach under the support section of a saddle-shaped container.

Advantageous saddle-shaped containers for an ensemble with a basket-shaped trellis (1) have on the underside of their support section structures designed to provide a connection, for example recesses formed as negative impressions of the basket structure which then accommodate the basket structure.

The space between the recesses further operates as an elongate bearing portion.

An advantageous embodiment of the structure of the base section (4) is for example designed to be elastic and adapts to the upper contour of an elongate support structure under the weight of the saddle-shaped container.

A long version of the trellis (1) for fruit-bearing plants, which is advantageous for large areas, has a basket-shaped body and can be arranged opposite one another such that two facing trellises arranged on the receiving side are connected to one another. For this purpose, the trellis (1) has a basket-shaped structure in cross-section with an end face that is open towards the receiving section (2), which is designed to receive fruit and forms the vertically oriented trellis structure (3).

The trellis (1) for arrangement on a plurality of planters has a plurality of receiving sections (2) and corresponding structures of the base sections (4) arranged underneath.

The trellis structure (3) is designed as a structure that supports plants, for example a lattice, a spiral, a diamond or a mesh. The structure can also be irregular and imitate characters, symbols or silhouettes, for example silhouettes of living beings, letters, logo, pagoda, tree, plant, building, cityscape, leaf or graphic shape. The course of the structure can be two-dimensional, for example in the form of a lattice, also around corners, or three-dimensional, such as living beings, a vehicle or a building, for example in the form of a tower.

The base section (4) has under the receiving section (2) a structure that corresponds to the opposing structure, for example with interlocking recesses and projections. The mutually corresponding elements are designed to create a connection between trellises (1). The recesses and projections are, for example, polygonal or round.

Advantageously designed, for example comb-shaped, structures are designed, for example with standardized lengths in relation to the diameters of saddle-shaped containers, so that a displacement of the base section (4) by one or more structures corresponds to a correspondingly offset receiving section (2) for a different saddle-shaped container diameter.

The receiving section (2) is designed as an open front side below the trellis structure (3) and above the base section (4), with the base section (4) reaching under the support section between the soil container sides of the saddle-shaped container and the sides of the saddle-shaped container being vertically enclosed by each receiving section (2).

The respective lengths of trellis structure (3) and base section (4) are identical or different.

In a more stable embodiment, trellis structures (3) lacing one another are designed as mutually corresponding elements, for example trellis webs, detents or clamps that can be plugged into one another.

In a further advantageously stable embodiment of the trellis structure (3), trellis structures (3) slide along one another and overlap, with opposing trellis structures (3) being designed as corresponding elements, for example interlocking trellis webs, detents or clamps.

A downward oriented structure designed as an attachment (6) which fastens the trellis (1) to an elongate support structure, such as a railing, extends from the base section (4). The attachment (6) is designed as an integral part of the trellis (1) and or as a separate part. Integral attachments (6) as components of the trellis (1) run along the base section (4) or are arranged individually and are designed, for example, as clips or brackets pointing downwards on the sides of the base section (4) to create a connection between the trellis and an elongate support structure. With respect to shape, course, cross-sectional design, material properties, the attachments (6) are designed to be solid or elastic.

When the attachments (6) as an integral part of the trellis (1) extend downwards on the sides of the base section (4), they accommodate the elongated support structure, like a railing, over a short length like a clamp or in a longer version like a tunnel, whereby they also bear against the sides.

The lateral downward height of the attachment (6) is advantageously dimensioned at least in sections such that it terminates approximately in the lower plane of the support structure that can be grasped from below, and a separate attachment (6), for example as a clip arranged transversely to the support structure, overlaps the base section (4). and engages under the underside of the support structure. For advantageously connecting the trellis (1) with separate attachments, the base section (4) has, preferably on its top side, suitable structures, such as rough surfaces or locking teeth, which communicate with structures of the separate attachments.

The separate attachments (6) are designed, for example, as clasps, clamps or cable ties, which create a connection between the trellis and an elongate support structure.

The trellis for balcony boxes is designed with or without a receiving section. Versions of the trellis are advantageously designed as a kit, which is designed in such a way that the number of its parts has more compact dimensions than the constructed trellis. For the use of special climbing plants, a pre-manufactured integral unit of trellis and planter is advantageous.

In use, the trellis with a continuous base portion is guided with the receiving portion around a soil container side of the saddle-shaped container until the base portion is disposed underneath the support section of the saddle-shaped container and the trellis structure is facing upward.

Where provided, adapters are included in the lower contour of the planter, and the planter is connected to the trellis, or the planter is connected to the trellis and the railing with cable ties.

On a three-dimensional trellis structure, such as a tower, the saddle-shaped container is inserted from above into the hollow interior of the tower, which is completely enclosed by the trellis structure, or one side of the tower has a gap or is designed as a gap or a door.

Trellis structures which have predetermined breaking points can expand the receiving section by separating them and/or can give the trellis an individual shape. The dimension of a base section with predetermined breaking points can be reduced by separation in order to reach underneath narrower support sections of saddle-shaped containers. When used with window boxes, the brackets are guided on the base section so that the brackets rest on the base section.

When used on saddle-shaped containers, the trellis with a separable receiving section is pushed onto the support section of the planter with this open and the snap-in connection is closed after it has been received.

The clasp-shaped trellis is guided from above in the expanded state with the sides of the base sections between the railing and the support section of the planter. Detachable sides of trellis structure and/or base sections are joined together. In use with window boxes, the sides of the base sections are inserted between the elongate support structure, such as railings, and brackets of the window box.

Detachable sides of trellis structure and/or base sections are joined together. The bridge-shaped trellis is placed from above on the elongated support structure, for example a wall, and attached thereto or also to the saddle-shaped container and accommodates the contour from the upper side of the railing of the planter in the receiving area.

The long version of the trellis is guided as a pair on each side of the saddle-shaped container, with a respective base section lying under the support section of the saddle-shaped container. Sides of base sections and detachable sides of trellis structures are joined together. Brackets are connected to the elongate support structure. When in use with balcony boxes, the brackets are guided onto the base sections of one or more trellises so that the brackets rest on the base sections.

The trellis for fruit-bearing plants is arranged underneath the saddle-shaped container by placing it in the receiving section from above.

A conventional planter, such as a balcony box or flower pot, is placed from above in the receiving area of the trellis for fruit-bearing plants.

The long version of the trellis for fruit-bearing plants is guided as a pair on either side of the saddle-shaped container, with a respective base section lying underneath the support section of the saddle-shaped container. Sides of base sections and detachable sides of trellis structures are joined together. The base sections and the detachable sides of the trellis structures are connected together. Brackets are connected to the elongate support structure.

When used with balcony boxes, the brackets are guided onto the base sections of one or more trellises so that the brackets rest on the base sections.

The use is simple, quick and clean, the trellis is placed outside the ground. The trellis has a stable support.

Particularly on saddle-shaped containers, the invention allows plant growth to be viewed in an advantageous line of sight from the soil depth from both container sides, regardless of the size of the plant container. It opens up several new, for example large-scale design options for balconies, railings and walls.

Trellises for arrangement on a number of saddle-shaped containers form as cascades balconies, railings and walls. The large areas designed with the invention act as attractive privacy and sun protection.

Attachment as a clasp, a bridge or a multi-part trellis is possible with an applied saddle-shaped container, which only has to be lifted slightly.

Designs for fruit-bearing plants accommodate fruit safely and on the sunny. Trellises designed as a kit reduce volume and costs during transport.

### REFERENCE LIST

Trellis 1
Receiving section 2
Trellis structure 3
Base section 4
Adapter 5
Attachment 6
Detent 7
Separation 8

Shown as an example are in

FIG. 1 the trellis (1) with a continuous base section (4),

FIG. 2 the trellis (1) with a separable receiving section (2),

FIG. 3 the trellis (1) as a clasp,

FIG. 4 the trellis (1) which can be arranged in two parts,

FIG. 5 the trellis (1) for fruit-bearing plants,

FIG. 6 the trellis (1) for fruit-bearing plants which can be arranged in two parts,

FIG. 7 the trellis as a tower with three sides,

FIG. 8 the trellis as a character.

3 sheets of drawings follow.

### REFERENCE LIST

Trellis 1
Receiving section 2
Trellis structure 3
Base section 4
Adapter 5
Attachment 6
Detent 7
Separation 8

1. A trellis (1) for arrangement on a saddle-shaped container, the saddle-shaped container having a concave indentation on an underside, the concave indentation having a substantially horizontal, longitudinally extended support section, and the support section being designed to transfer a weight force of the saddle-shaped container to an elongated support structure, the trellis (1) comprising:
a receiving section (2), a trellis structure (3) and a base section (4),
wherein the base section (4) has an elongate basic shape arrangeable at least in sections between the support section of the saddle-shaped container and the support structure,
wherein the trellis structure (3) is connected in a fixed position to the base section (4) and is arranged in an ascending or descending manner in relation to the base section (4).

2. The trellis (1) according to claim 1, wherein the support section and the base section (4) are two-dimensional.

3. The trellis (1) according to claim 1, wherein the trellis structure (3) is made of an elastic material.

4. The trellis (1) according to claim 1, wherein the trellis structure (3) is designed as a handle.

5. The trellis (1) according to claim 1, wherein the trellis structure (3) is arcuate and is connected to the base section (4) at two ends of the trellis at two connection points,
wherein the connection points are arranged at opposing base section ends of the base section (4) and the saddle-shaped container is arranged in a horizontal extension of the base section (4) between the connection points.

6. The trellis (1) according to claim 5, wherein the base section (4) is formed in two parts and forms two base section parts, with each of the base section parts having one of the two connection points.

7. The trellis (1) according to claim 6, wherein the base section parts are designed to be detachably connectable to one another.

8. The trellis (1) according to claim 1, wherein the base section (4) is designed to be elastic and is designed to adapt under the weight of the saddle-shaped container to a contour of the support structure on which the base section (4) rests.

9. The trellis (1) according to claim 1, wherein a region of the trellis which is not covered by the support section and further rests on the support structure has attachments (6) which are designed to connect the trellis to the support structure.

10. The trellis (1) according to claim 1, wherein the base section (4) has two different top sides, each having a different cross-section in a longitudinal direction, and is designed so as to be turned and connected to the trellis structure (3).

11. The trellis (1) according to claim 1, wherein the base section (4) is formed from several planes, with an upper plane detachably connected to the trellis structure (3) or firmly connected to the trellis structure (3).

12. The trellis (1) according to claim 1, wherein the trellis has at least one predetermined breaking point.

13. The trellis (1) according to claim 1, further comprising adapters (5) which are designed to connect the trellis to the saddle-shaped container.

14. The trellis (1) according to claim 13, wherein the adapters (5) are designed as hollow profiles and constructed to accommodate separate connecting elements.

15. The trellis (1) according to claim 1, wherein the trellis is designed as a finished part or as a kit.

16. The trellis (1) according to claim 7, wherein the trellis structure has elastically designed structures disposed above the multi-part base section (4) near the receiving section (2), and that trellis structures (3) slide along one another and overlap.

17. The trellis (1) according to claim 3, wherein the trellis structure (3) in the form of a clasp.

18. The trellis (1) according to claim 5, wherein the trellis structure (3) is made of an elastic material.

19. The trellis (1) according to claim 14, wherein the separate connecting elements are cable ties.
